(19) United States
(12) Patent Application Publication
(10) Pub. No.: US 2026/0219178 A1
(43) Pub. Date: Jul. 30, 2026

(54) SPECTROSCOPIC DISPENSE RATIO MEASUREMENT SYSTEMS FOR TWO-PART POLYMERIC MATERIALS

(71) Applicant: GM GLOBAL TECHNOLOGY OPERATIONS LLC, Detroit, MI (US)

(72) Inventors: Michael J. Lukitsch, Marysville, MI (US); Mary Gilliam, Farmington Hills, MI (US); Blair E. Carlson, Ann Arbor, MI (US); Nicholas Paul William Pieczonka, Windsor (CA); William Reginald Collin, Dearborn, MI (US); Nicholas P. Irish, Waterford, MI (US); Jennifer Therese Bracey, Holly, MI (US); Robert H. Dietze, Brighton, MI (US); Christopher Brady, Madison Heights, MI (US)

(21) Appl. No.: 19/037,396

(22) Filed: Jan. 27, 2025

(51) Int. Cl. G01N 21/359; B67D 7/74; G01N 21/25; G01N 21/35; G01N 21/3577; G01N 21/65

(52) U.S. Cl. CPC G01N 21/359; B67D 7/74; G01N 21/251; G01N 21/3577; G01N 21/65; G01N 2021/3595

(57) ABSTRACT

An example two-part polymer dispensing system includes a mixing tube configured to mix a first and second polymer materials to produce an adhesive material, a nozzle to dispense the adhesive material including a mixture of the first and second polymer materials, a light source configured to direct light towards the adhesive material, one or more detectors configured to detect spectroscopic data of at least one of light reflected off of the adhesive material or light transmitted through the adhesive material, and a control module configured to compare the spectroscopic data from the detector(s) to a specified spectroscopic data threshold range, wherein the specified spectroscopic data threshold range corresponds to a specified range a mixture ratio of the first polymer material to the second polymer material, and in response to the spectroscopic data being outside of the specified spectroscopic data threshold range, generate a notification of incorrect polymer mixture ratio.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure generally relates to spectroscopic dispense ratio measurement for two-part polymeric materials.

Polymeric materials are sometimes mixed together to form adhesive materials for vehicle battery modules. The polymeric materials are mixed at a specific ratio to create desirable adhesive material properties. Spot-check audits may be performed several times a day to determine whether weight percentages of each polymer material in the resulting adhesive material are correct.

### SUMMARY

An example two-part polymer dispensing system includes a mixing tube configured to mix a first polymer material and a second polymer material to produce an adhesive material, a nozzle coupled with the mix tube to dispense the adhesive material including a mixture of the first polymer material and the second polymer material, at least one light source configured to direct light towards the adhesive material, one or more detectors configured to detect spectroscopic data of at least one of light reflected off of the adhesive material or light transmitted through the adhesive material, and a control module configured to obtain the spectroscopic data from the one or more detectors, compare the spectroscopic data to a specified spectroscopic data threshold range, wherein the specified spectroscopic data threshold range corresponds to a specified range a mixture ratio of the first polymer material to the second polymer material, and in response to the spectroscopic data being outside of the specified spectroscopic data threshold range, generate a notification of incorrect polymer mixture ratio.

In some examples, the control module is configured to, in response to the spectroscopic data being outside of the specified spectroscopic data threshold range, automatically change the mixture ratio of the first polymer material to the second polymer material in the mixing tube, according to a value of the spectroscopic data.

In some examples, the control module is configured to automatically change the mixture ratio of the first polymer material to the second polymer material using negative feedback proportional-integral-derivative (PID) control or ratio control.

In some examples, the adhesive material including the mixture of the first polymer material and the second polymer material is a thermal interface material (TIM) or a structural adhesive material (SAM).

In some examples, the adhesive material including the mixture of the first polymer material and the second polymer material is a vehicle battery module adhesive material.

In some examples, the at least one light source and the one or more detectors are mounted adjacent at least one of the mixing tube or the nozzle, and the control module is configured to obtain the spectroscopic data at a specified periodic time interval.

In some examples, the one or more detectors include a near infrared (NIR) sensor configured to operate in an absorbance mode or a transmission mode. In some examples, the one or more detectors include a Fourier-transform infrared spectroscopy (FTIR) sensor configured to operate in an absorbance mode or a transmission mode.

In some examples, the one or more detectors include a Raman sensor configured to operate in a reflection mode or a transmission mode. In some examples, the one or more detectors include one or more detectors include a colorimeter configured to scan the adhesive material including the mixture of the first polymer material and the second polymer material.

In some examples, the control module is configured to process the spectroscopic data to determine at least one of tristimulus values corresponding to the adhesive material, chromaticity values corresponding to the adhesive material or a chromaticity plot corresponding to the adhesive material.

In some examples, the control module is configured to process the spectroscopic data to determine at least one of a lightness measurement corresponding to the adhesive material, a green-red shift measurement corresponding to the adhesive material or a blue-yellow shift measurement corresponding to the adhesive material.

In some examples, the at least one light source is configured to direct light at an adhesive material sampling location, and the adhesive material sampling location includes at least one of a pre-dispense location between the mixing tube and the nozzle, a nozzle location at an end of the nozzle, a dispensed-on-part location along a bead path of the adhesive material, and an offline spot-check location.

In some examples, the system includes at least one flow meter in communication with the mixing tube, wherein the flow meter is configured to detect a flow of at least one of the first polymer material and the second polymer material according to a Coriolis principle.

An example method for two-part polymer dispensing includes mixing a first polymer material and a second polymer material in a mixing tube of an adhesive material dispensing system, dispensing, via a nozzle coupled with the mix tube, an adhesive material including a mixture of the first polymer material and the second polymer material, directing light towards the adhesive material from at least one light source, detecting spectroscopic data of at least one of light reflected off of the adhesive material or light transmitted through the adhesive material, comparing the spectroscopic data to a specified spectroscopic data threshold range, wherein the specified spectroscopic data threshold range corresponds to a specified range a mixture ratio of the first polymer material to the second polymer material, and in response to the spectroscopic data being outside of the specified spectroscopic data threshold range, generate a notification of incorrect polymer mixture ratio.

In some examples, the method includes, in response to the spectroscopic data being outside of the specified spectroscopic data threshold range, automatically changing the mixture ratio of the first polymer material to the second polymer material in the mixing tube, according to a value of the spectroscopic data.

In some examples, changing the mixture ratio includes automatically changing the mixture ratio of the first polymer material to the second polymer material using negative feedback proportional-integral-derivative (PID) control or ratio control.

In some examples, the adhesive material including the mixture of the first polymer material and the second polymer material is a thermal interface material (TIM) or a structural adhesive material (SAM).

In some examples, the adhesive material including the mixture of the first polymer material and the second polymer material is a vehicle battery module adhesive material.

In some examples, detecting the spectroscopic data includes detecting spectroscopic data using at least one of a near infrared (NIR) sensor configured to operate in an absorbance mode or a transmission mode, a Fourier-transform infrared spectroscopy (FTIR) sensor configured to operate in an absorbance mode or a transmission mode, and a Raman sensor configured to operate in a reflection mode or a transmission mode.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a diagram of an example system for spectroscopic dispense ratio measurement of two-part polymeric materials.

FIG. 2 is a block diagram depicting an example light source and detector arrangement for spectroscopic dispense measurement in the system of FIG. 1.

FIG. 3 is a diagram depicting an example flow meter for detecting flow of polymeric materials in the system of FIG. 1.

FIG. 4 is a flowchart depicting an example process for spectroscopic dispense ratio measurement of two-part polymeric materials.

FIG. 5 is a flowchart depicting an example process for spectroscopic dispense ratio measurement of two-part polymeric materials using a colorimeter.

FIG. 6 is a flowchart depicting an example process for flow measurement of polymeric materials using a flow meter.

FIG. 7 is a flowchart depicting an example process for spectroscopic dispense ratio measurement of two-part polymeric materials using different example sensors.

In the drawings, reference numbers may be reused to identify similar and/or identical elements.

### DETAILED DESCRIPTION

In some example embodiments, spot-check and/or in-line systems are described to measure, monitor, and control dispense ratios of two-part polymeric materials, such as thermal interface materials (TIM) and structural adhesive materials (SAM) utilized in battery module assemblies or similar manufacturing processes. The systems may be based on applications of appropriate spectroscopic measurement techniques, and select mass flow meters capable of non-contact and real-time sampling.

This provides more accurate and precise delivery of two-part polymers reactants as compared to off-line spot checking using weight percentage measurements, enabling better overall process control and optimized material performance. Example method described herein may increase efficiency during the manufacturing process by more accurately and expeditiously determining the mixing ratio of dispensed two-component polymer materials utilized in production.

In some example embodiments, spectroscopic techniques are used to differentiate the mixing ratios of two-part adhesives and thermal interface materials for battery pack assembly, as quality inspection and process control. For example, Fourier-transform infrared (FTIR) sensors, Raman sensors, near infrared (NIR) sensors, UV-Vis-spectrophotometers, etc., may be utilized as to monitor composition of the mixed polymer adhesive at any point in the process. This may be applied to any multicomponent dispensing system where composition at the dispensing nozzle needs to be ensured.

Example process control schemes may incorporate spectroscopic data, extract appropriate differentiation peaks, correlate the data to a mix ratio, and use them as an input to control material flow via pump or control valve in real time. Some examples may utilize the pigments added to each component, and correlate color measurements to the mix ratio or mass percent of components.

For example, color data may include the XYZ 3D color space, a chromaticity diagram, and/or L*a*b* measurements (such as lightness measurements, green-red shift measurements, and blue-yellow shift measurements). Correlations may be based on the absolute values or the difference between the sample, and a baseline sample having a target ratio. Using the difference may eliminate a need to establish new control and specification limits for new batches that have different concentrations of pigment.

In some examples, validation and data input for ancillary process control systems such as Coriolis flow meter and dielectric sensors. Tailored detection criteria of mixing ratio anomalies may be implemented for acceptable/unacceptable mix ratio ranges. Anomalies may be detected in real-time. Flexible spectroscopic techniques may be incorporated post dispense, or inline through appropriate glass windows or ports.

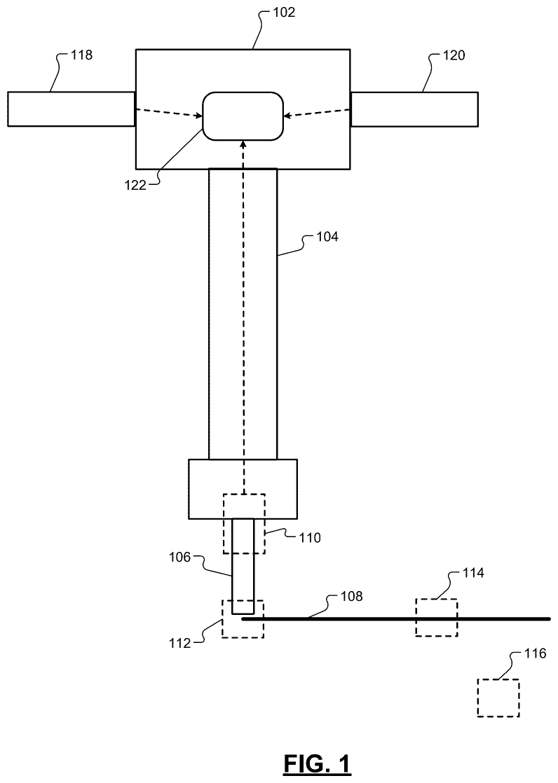

FIG. 1 is a diagram of an example system for spectroscopic dispense ratio measurement of two-part polymeric materials. As shown in FIG. 1, a two-part polymer dispensing system 102 is configured to supply two polymer materials through a mixing tube 104.

The mixing tube 104 may allow the two polymer materials to mix with one another, to create an adhesive material (e.g., via a chemical reaction between the two polymer materials, etc.). Although FIG. 1 illustrates a two-part polymer dispensing system, in other example embodiments more than two polymer materials may be mixed to form one or more products, such as one or more adhesives.

As shown in FIG. 1, a dispense tip 106 is coupled with the mixing tube 104. The dispense tip 106 includes a nozzle, which dispense adhesive material. The dispensed adhesive material includes a mixture of the two polymer materials. The adhesive material may be dispensed from the nozzle in any suitable manner, such as a bead path 108. The adhesive material may be any suitable material, such as a thermal interface material (TIM) or structural adhesive material (SAM) for a vehicle battery module.

The two-part polymer dispensing system 102 includes a control module 122. The control module 122 may be located on a component of the two-part polymer dispensing system 102, within a component of the two-part polymer dispensing system 102, or separate from the two-part polymer dispensing system 102.

The control module 122 may control one or more operations of the two-part polymer dispensing system 102, such as an amount of each polymer material supplied to the mixing tube 104. For example, the control module 122 may be configured to operate one or more pumps, valves, etc., to separately control an amount of each different polymer material supplied to the mixing tube 104, how much the polymer materials are mixed within the mixing tube 104, how fast or slow adhesive material is dispensed from the nozzle (or whether dispensing is stopped or started), etc.

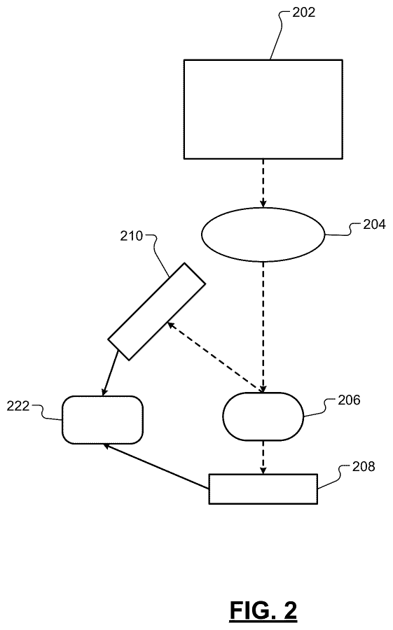

The control module 122 may be configured to receive spectroscopic data from one or more sensors, flow data from one or more sensors, etc., to determine a mixing ratio of the different polymer materials in the dispensed adhesive material. For example, as described in FIG. 2, one or more light sources 202 may be configured to direct light toward a sample 206 of adhesive material.

Referring again to FIG. 1, the sampling location may be any suitable location for gathering spectroscopic data related to the mixture of polymer materials in the adhesive material, such as pre-dispense sampling 110 in the dispense tip 106 or the mixing tube 104 (e.g., while the adhesive material is still in the system), or nozzle sampling 112 at an end of the dispense tip 106 (e.g., as the adhesive material is exiting the system and being dispensed onto a component).

In some examples, one or more light sources 202 may be directed towards a sampling location along the bead path 108, such as dispensed-on-part sampling 114. As another example, offline spot-check sampling 116 may be implemented to check resulting adhesive materials at other locations away from the two-part polymer dispensing system.

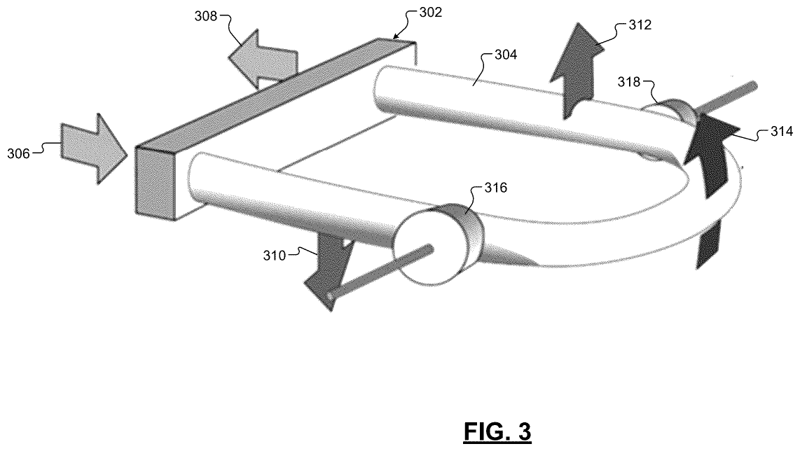

FIG. 1 also illustrates a first Coriolis mass flow meter 118, and a second Coriolis mass flow meter 120. Each flow meter may be configured to receive a flow of a different one of the polymer materials, and to measure an amount of flow using the Coriolis principle, which is indicative of an amount of that polymer material being added to the mixture to determine a mix ratio of the two polymer materials in the resulting adhesive material. Further example details of the first Coriolis mass flow meter 118 and the second Coriolis mass flow meter 120 are described below with reference to FIG. 3. The control module 122 may be configured to receive signals from the first Coriolis mass flow meter 118 and the second Coriolis mass flow meter 120, and any detectors such as different light sensors located at the pre-dispense sampling 110, the nozzle sampling 112, the dispensed-on-part sampling 114, and the offline spot-check sampling 116.

FIG. 2 is a block diagram depicting an example light source and detector arrangement for spectroscopic dispense measurement in the system of FIG. 1. As shown in FIG. 2, the light source 202 is configured to direct light towards a sample 206, which may be an adhesive material including a mixture of two different polymer materials.

A first detector 208 is positioned to detect light that passes through the sample 206, and a second detector is positioned to detect light that is reflected off of the sample 206. Each detector may include any suitable sensor for detecting spectroscopic data based on the light passing through and/or reflecting off of the sample 206, such as a Fourier-transform infrared (FTIR) sensor, a near infrared (NIR) sensor, a Raman sensor, a colorimeter, etc.

The first detector 208 and the second detector 210 may be coupled with a control module 222 to provide spectroscopic data. Each detector may be positioned at any suitable location to detect spectroscopic data, such as the pre-dispense sampling 110 FIG. 1, the nozzle sampling 112, the dispensed-on-part sampling 114, or the offline spot-check sampling 116.

As shown in FIG. 2, one or more filters may be used between the light source 202 and the sample 206, or between the sample 206 and one of the detectors. Any suitable filters may be used, which may correspond to a type of light emitted by the light source 202.

FIG. 3 is a diagram depicting an example flow meter for detecting flow of polymeric materials in the system of FIG. 1. As shown in FIG. 3, an inflow 306 of polymer material enters the flow meter 302, passes through a tube 304 of the flow meter 302, and an outflow 308 of polymer material exits the flow meter 302.

The tube 304 is U-shaped, and the flow of polymer material through the tube 304 creates a downward fluid force 310 on side of the tube and an upward fluid force 312 on another end of the tube 304. This may create a tube oscillation 314. A first velocity sensor 316 and a second velocity sensor 318 may be configured to detect a velocity of flow of polymer material through the tube 304.

The flow meter 302 may be used to determine a flow of polymer material, such as by using the Coriolis principle. The Coriolis force is an inertial force which acts on objects in motion within a frame of reference that rotates with respect to an inertial frame. In a reference frame with clockwise rotation, the force acts to the left of the motion of the object. In one with anticlockwise (or counterclockwise) rotation, the force acts to the right. Deflection of an object due to the Coriolis force is a Coriolis effect.

The magnitude of the Coriolis force is proportional to the rotation rate, and the magnitude of the centrifugal force is proportional to the square of the rotation rate. The Coriolis force acts in a direction perpendicular to two quantities: the angular velocity of the rotating frame relative to the inertial frame and the velocity of the body relative to the rotating frame, and its magnitude is proportional to the object's speed in the rotating frame. The centrifugal force acts outwards in the radial direction and is proportional to the distance of the body from the axis of the rotating frame.

In some example embodiments, a sensor may be integrated in the dispensing unit, which captures spectroscopic data used to determine the mix ratio of two-part adhesives and thermal management materials for battery pack assemblies. The data acquisition system may extract data from the spectra and automatically calculate the mix ratio based on a pre-programmed algorithm, such extracting data of specific peak height, peak area, or ratios thereof that is used to calculate the ratio, or using an artificial intelligence (AI) imaging model that is trained to extract features of the spectra that correlate to the mix ratios.

In some examples, color measurements of the blended two-part adhesive are correlated to the mix ratio of components, where the color measurements are obtained using a colorimeter that scans a sample of the blended adhesive that is covered with a transparent plastic film or window. The colorimeter may obtain tristimulus values X, Y, and Z, chromaticity values x and y, a chromaticity plot of the obtained values, etc.

In some examples, a colorimeter may obtain L* (lightness), a* (green-red), b* (blue-yellow) measurements. For example, the L* measurements may be obtained when at least one component is white, black, or a shade of grey. The a* measurements may be obtained when blending the two polymer materials creates a change in the red-green range. The b* measurements may be obtained when blending the two polymer materials creates a change in the blue-yellow range. The may compare a difference in one or more color measurements between an established baseline and a sample of the dispensed adhesive in production.

In some examples, mass flow meters based on the Coriolis principle are used to determine and control the mix ratio of two-part adhesives and thermal management materials for battery pack assemblies. The flow meters may be integrated with spectroscopic analysis systems, where the meters are used for establishing the correlations between the spectroscopic data and the mix ratio of the components. The flow meters may be integrated into a ratio control scheme that includes the mass flow ratio data from the flow meters and the spectroscopic data, as input parameters for manipulating a dispense valve or pump for one or both polymer materials to achieve the target ratio.

A near infrared (NIR) sensor may be used in either absorbance or transmission mode before the dispensing nozzle (e.g., with a window), at the dispensing nozzle, or post-dispense on part, or a spot-check sample, to quantify the mix ratio. This output may be connected to the dispensing system, and the dispensing system may be controlled using a negative feedback PID controller to ensure that the proper composition is achieved. In some examples, an NIR sensor may also be utilized to monitor for moisture in the dispensing system, if water contamination is a concern.

In some examples, a Fourier-transform infrared spectroscopy (FTIR) sensor may be used in either absorbance or transmission mode before the dispensing nozzle (e.g., with a window), at the dispensing nozzle, or post-dispense on part, or a spot-check sample, to quantify the mix ratio. This output may be connected to the dispensing system, and the dispensing system may be controlled using a negative feedback PID controller to ensure that a proper composition is achieved.

A Raman sensor may be used in either reflection or transmission mode before the dispensing nozzle (e.g., with a window), at the dispensing nozzle, or post-dispense on part, or a spot-check sample, to quantify the mix ratio. This output may be connected to the dispensing system, and the dispensing system may be controlled using a negative feedback PID controller to ensure that the proper composition is achieved.

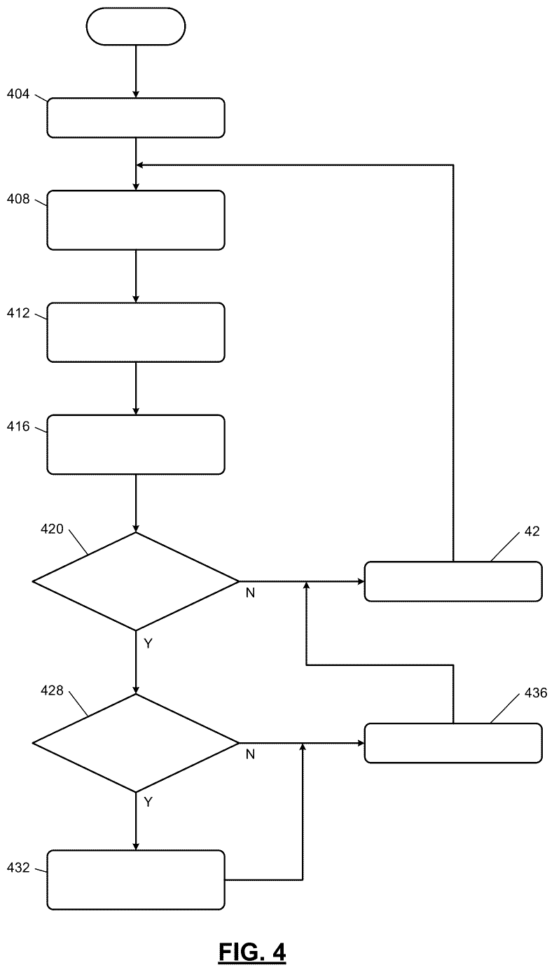

FIG. 4 is a flowchart depicting an example process for spectroscopic dispense ratio measurement of two-part polymeric materials. The example process of FIG. 4 may be performed by, for example, the control module 122 of FIG. 1. At 404, the process begins by initiating dispensing of two-part polymer material (such as via the mixing tube 104 and dispense tip 106 of the two-part polymer dispensing system 102 in FIG. 1).

At 408, the control module is configured to direct a light source towards a two-part polymer sample location, such as the pre-dispense sampling 110 FIG. 1, the nozzle sampling 112, the dispensed-on-part sampling 114, or the offline spot-Check sampling 116.

At 412, the control module is configured to capture spectroscopic data of a two-part polymer sample location. The control module then compares processed spectroscopic data to a threshold range at 416. At 420, the control module determines whether the spectroscopic data is outside of the specified threshold range.

If not, the control module is configured to wait for a next sampling period at 424 (e.g., at intervals of one minute, ten minutes, one hour, four hours, etc.), and then return to 408 to direct the light source towards the adhesive material to obtain another sample.

If the spectroscopic data is outside of the threshold range at 420, control proceeds to 428 to determine whether automated control is active. If not, control generates a notification of an incorrect mixing ratio at 436, such as an alert, an audible alarm, transmitting a message or email, etc.

If automate control is active at 428, control proceeds to 432 to automatically adjust dispensing equipment to obtain a correct, desired mixing ratio. For example, the control module may further open a valve of a polymer material which is too low in the mixing ratio based on the spectroscopic data, may increase a pump operation speed for a polymer material which is too low in the mixing ratio based on the spectroscopic data, etc.

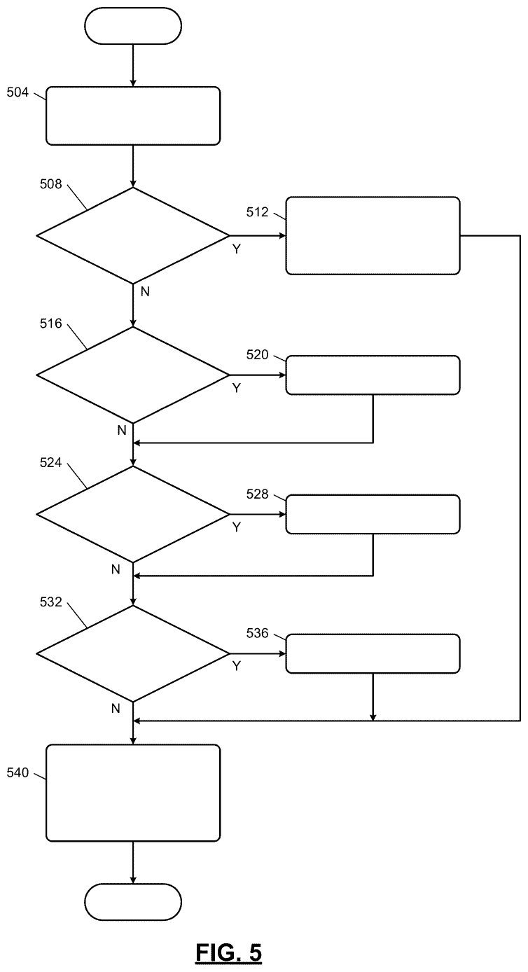

FIG. 5 is a flowchart depicting an example process for spectroscopic dispense ratio measurement of two-part polymeric materials using a colorimeter. The example process of FIG. 5 may be performed by, for example, the control module 122 of FIG. 1. At 504, the process begins by scanning a sample of a blended two-part polymer material with a colorimeter.

At 508, control determines whether tristimulus values have been set for comparison. If so, the control module is configured to obtain, at 512, tristimulus values from the spectroscopic data, chromaticity values from the spectroscopic data, a chromaticity plot from the spectroscopic data, etc.

At 516, the control module is configured to determine whether a polymer material of the adhesive material is white, black or grey. If so, control proceeds to 520 to obtain a lightness value from the colorimeter scan. At 524, the control module is configured to determine whether the polymer blend (e.g., the two polymer materials mixed together to generate the adhesive) contains a red-green change.

For example, when some polymer materials are mixed together, the resulting mixture may cause a color of a polymer material to shift from red to green. If the polymer blend contains a red-green change, the control module is configured to obtain a green to red shift value from the colorimeter scan at 528.

At 532, the control module is configured to determine whether the polymer blend contains a blue-yellow change. For example, when some polymer materials are mixed together, the resulting mixture may cause a color of a polymer material to shift from blue to yellow. If the polymer blend contains a blue-yellow change, the control module is configured to obtain a blue to yellow shift value from the colorimeter scan at 536. Control then compares the sample values to baseline target values to determine whether the mix ratio is within a specified range.

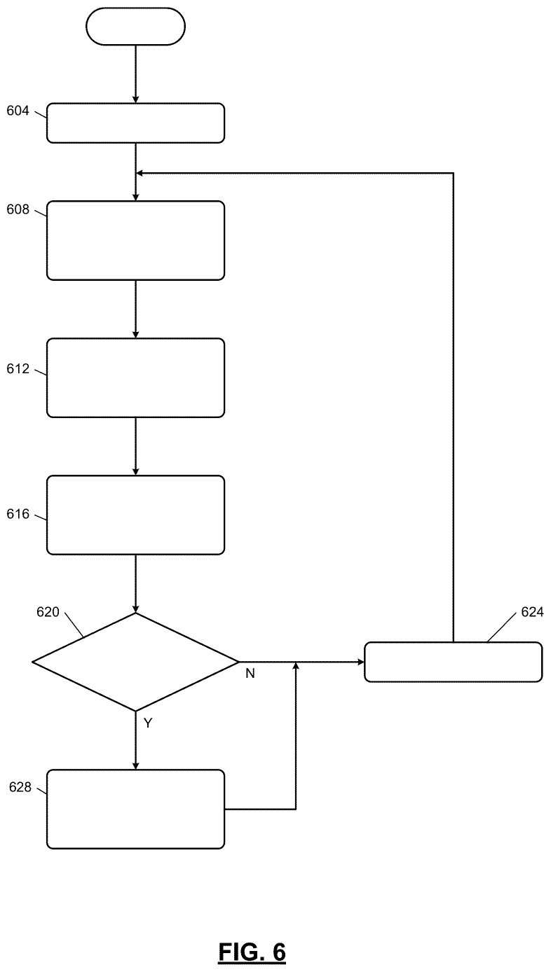

FIG. 6 is a flowchart depicting an example process for flow measurement of polymeric materials using a flow meter. The example process of FIG. 6 may be performed by, for example, the control module 122 of FIG. 1. At 604, the process begins by initiating dispensing of two-part polymer material.

At 608, the control module is configured to determine a flow of a first polymer material using a flow meter and the Coriolis principle. Control then determines a flow of a second polymer material at 612, using another flow meter and the Coriolis principle.

At 616, the control module is configured to establish a correlation between spectroscopic data, and a mix ratio of the polymer materials, based on the flow meters. Control then determines whether the spectroscopic data is outside of a threshold range, at 620.

If the spectroscopic data is not outside of the threshold range at 620, control proceeds to 624 to wait for a next sampling period. If the spectroscopic data is outside of the threshold range at 620, control proceeds to 628 to automatically adjust a dispense valve or pump of dispensing equipment, to correct the mixing ratio based on the spectroscopic data.

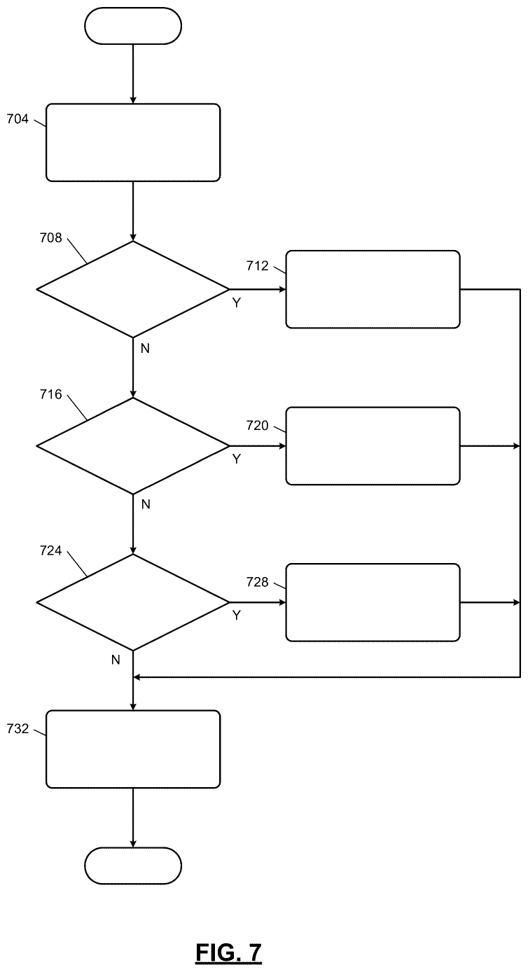

FIG. 7 is a flowchart depicting an example process for spectroscopic dispense ratio measurement of two-part polymeric materials using different example sensors. The example process of FIG. 7 may be performed by, for example, the control module 122 of FIG. 1. At 704, the process begins by scanning a sample of a blended two-part polymer material with a spectroscopic sensor.

At 708, the control module is configured to determine whether a near infrared (NIR) sensor is being used in the system. If so, control proceeds to 712 to compare NIR sensor data (e.g., in absorbance mode or transmission mode), with a baseline range.

At 716, the control module is configured to determine whether a Fourier transform infrared (FTIR) sensor is being used in the system. If so, control proceeds to 720 to compare FTIR sensor data (e.g., in absorbance mode or transmission mode), with a baseline range.

At 724, the control module is configured to determine whether a Raman sensor is being used in the system. If so, control proceeds to 728 to compare NIR sensor data (e.g., in reflection mode or transmission mode), with a baseline range. The control module then controls a dispensing ratio of the two polymer materials based on the comparison at 732, such as by using a negative feedback PID controller or ratio control.

In some example embodiments, colorimetry may be used where samples of a two-part adhesive are mixed at various ratios of pass and fail with an example target of 50 wt. % each and a specification range of 47.6 wt. %-52.4 wt. %. An example baseline for 50 wt. % may established (L*=56.96, a*=−19.67, and b*=−33.32). There may be a clear separation between the passing samples and the failed samples. As an example, suggested upper and lower limits for an example adhesive may be −0.1 to 0.1 for dL* and −0.2 to 0.2 for db*.

In FTIR spectroscopy, example samples of two-part adhesive (SAM) and two-part thermal management (TIM) materials may be mixed at various mix ratios each corresponding to pass and fail. An example baseline for 50 wt. % mix ratios may be established and a specification range of 47.6 wt. %-52.4 wt. % for alarm and failure conditions for TIM material. An example baseline for a SAM material may be established and a specification range of 31.5 wt. %-35.5 wt. % of the hardener for alarm and failure conditions.

In some examples, attenuated total internal reflection Fourier-transform infrared spectroscopy may be used. For example, a broad spectrum of light may be sent through a crystal at such an angle as to allow total internal reflectance. At the point of reflection, an evanescent wave may propagate past the surface of the crystal. Contact between the sample and the surface of the crystal may allow probing of the sample by the evanescent wave, and absorption of some of the IR energy. Comparing energy spectra with and without a sample present produces an IR spectrum for the samples.

In some cases, samples may be applied directly to a diamond ATR crystal, where only freshly mixed samples are used, and the system is cleaned thoroughly with methanol or other suitable solvents in between and immediately after sample analysis.

For Raman spectroscopy, example samples of two-part adhesive (SAM) and two-part thermal management (TIM) materials may be mixed at various mix ratios each corresponding to pass and fail. An example baseline for 50 wt. % TIM mix ratios me established and a specification range of 45.5 wt. %-54.5 wt. % indicating failure. Raman spectroscopy may include a non-destructive, laser based, chemical analysis technique which provides detailed information about chemical structure, phase and polymorphy, crystallinity and molecular interactions.

Some example embodiments may provide one or more benefits or advantages, such as replacing a current static cup weighing method which excessively interrupts production and is labor intensive. Example methods describe herein may be integrated with the dispensing unit and be used in dispense process control.

In some examples, actual operative chemical constituent(s) can be measured with the appropriate algorithms. This is important as more functionality of material systems develop and the need to precisely control their mixture becomes more critical to performance.

The Coriolis mass flow meters may enable mass flow-controlled dispensing, instead of the volumetric flow-controlled dispensing that can be sensitive to changes in temperature, and viscosity or pressure as a non-Newtonian fluid. The Coriolis mass flow meters may be coupled with the spectroscopic techniques to effectively be integrated into the control loop, to control mix ratios with improved accuracy and precision in-situ. This complementary approach may compensate for drum to drum, batch to batch, and top-of-barrel to bottom-of-barrel variation, in the active chemicals of the polymer materials.

Raman spectroscopy may be implemented in a non-contact mode, and with appropriate lenses, large working distances. The mode of measurement for other spectroscopic techniques that typically require sample contact, can be made non-contact with the appropriate choice of sight-glass sampling windows.

The equipment cost of example approaches herein may be quickly recovered by, for example, reduction or elimination of multiple daily production down time interruptions, reduction or elimination of human error in measurement, reduction or elimination of labor costs associated with the process of weighing samples and re-assembly of dispense unit, reduction or elimination of safety risk of labor entering dispense cell, more accurate and precise measurement, better and more robust process control if integrated into the dispense system, less sensitivity to environmental factors, and a decrease in potential labor exposure to chemicals.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A two-part polymer dispensing system, the system comprising:
a mixing tube configured to mix a first polymer material and a second polymer material to produce an adhesive material;
a nozzle coupled with the mix tube to dispense the adhesive material including a mixture of the first polymer material and the second polymer material;
at least one light source configured to direct light towards the adhesive material;
one or more detectors configured to detect spectroscopic data of at least one of light reflected off of the adhesive material or light transmitted through the adhesive material; and
a control module configured to:
obtain the spectroscopic data from the one or more detectors;
compare the spectroscopic data to a specified spectroscopic data threshold range, wherein the specified spectroscopic data threshold range corresponds to a specified range a mixture ratio of the first polymer material to the second polymer material; and
in response to the spectroscopic data being outside of the specified spectroscopic data threshold range, generate a notification of incorrect polymer mixture ratio.

2. The system of claim 1, wherein the control module is configured to, in response to the spectroscopic data being outside of the specified spectroscopic data threshold range, automatically change the mixture ratio of the first polymer material to the second polymer material in the mixing tube, according to a value of the spectroscopic data.

3. The system of claim 2, wherein the control module is configured to automatically change the mixture ratio of the first polymer material to the second polymer material using negative feedback proportional-integral-derivative (PID) control or ratio control.

4. The system of claim 1, wherein the adhesive material including the mixture of the first polymer material and the second polymer material is a thermal interface material (TIM) or a structural adhesive material (SAM).

5. The system of claim 4, wherein the adhesive material including the mixture of the first polymer material and the second polymer material is a vehicle battery module adhesive material.

6. The system of claim 1, wherein:
the at least one light source and the one or more detectors are mounted adjacent at least one of the mixing tube or the nozzle; and
the control module is configured to obtain the spectroscopic data at a specified periodic time interval.

7. The system of claim 1, wherein the one or more detectors include a near infrared (NIR) sensor configured to operate in an absorbance mode or a transmission mode.

8. The system of claim 1, wherein the one or more detectors include a Fourier-transform infrared spectroscopy (FTIR) sensor configured to operate in an absorbance mode or a transmission mode.

9. The system of claim 1, wherein the one or more detectors include a Raman sensor configured to operate in a reflection mode or a transmission mode.

10. The system of claim 1, wherein the one or more detectors include one or more detectors include a colorimeter configured to scan the adhesive material including the mixture of the first polymer material and the second polymer material.

11. The system of claim 10, wherein the control module is configured to process the spectroscopic data to determine at least one of tristimulus values corresponding to the adhesive material, chromaticity values corresponding to the adhesive material or a chromaticity plot corresponding to the adhesive material.

12. The system of claim 10, wherein the control module is configured to process the spectroscopic data to determine at least one of a lightness measurement corresponding to the adhesive material, a green-red shift measurement corresponding to the adhesive material or a blue-yellow shift measurement corresponding to the adhesive material.

13. The system of claim 1, wherein:
the at least one light source is configured to direct light at an adhesive material sampling location; and
the adhesive material sampling location includes at least one of a pre-dispense location between the mixing tube and the nozzle, a nozzle location at an end of the nozzle, a dispensed-on-part location along a bead path of the adhesive material, and an offline spot-check location.

14. The system of claim 1, further comprising at least one flow meter in communication with the mixing tube, wherein the flow meter is configured to detect a flow of at least one of the first polymer material and the second polymer material according to a Coriolis principle.

15. A method for two-part polymer dispensing, the method comprising:
mixing a first polymer material and a second polymer material in a mixing tube of an adhesive material dispensing system;
dispensing, via a nozzle coupled with the mix tube, an adhesive material including a mixture of the first polymer material and the second polymer material;
directing light towards the adhesive material from at least one light source;
detecting spectroscopic data of at least one of light reflected off of the adhesive material or light transmitted through the adhesive material;
comparing the spectroscopic data to a specified spectroscopic data threshold range, wherein the specified spectroscopic data threshold range corresponds to a specified range a mixture ratio of the first polymer material to the second polymer material; and
in response to the spectroscopic data being outside of the specified spectroscopic data threshold range, generate a notification of incorrect polymer mixture ratio.

16. The method of claim 15, further comprising, in response to the spectroscopic data being outside of the specified spectroscopic data threshold range, automatically changing the mixture ratio of the first polymer material to the second polymer material in the mixing tube, according to a value of the spectroscopic data.

17. The method of claim 16, wherein changing the mixture ratio includes automatically changing the mixture ratio of the first polymer material to the second polymer material using negative feedback proportional-integral-derivative (PID) control or ratio control.

18. The method of claim 17, wherein the adhesive material including the mixture of the first polymer material and the second polymer material is a thermal interface material (TIM) or a structural adhesive material (SAM).

19. The method of claim 18, wherein the adhesive material including the mixture of the first polymer material and the second polymer material is a vehicle battery module adhesive material.

20. The method of claim 15, wherein detecting the spectroscopic data includes detecting spectroscopic data using at least one of:
a near infrared (NIR) sensor configured to operate in an absorbance mode or a transmission mode;
a Fourier-transform infrared spectroscopy (FTIR) sensor configured to operate in an absorbance mode or a transmission mode; and
a Raman sensor configured to operate in a reflection mode or a transmission mode.
